(19) United States
(12) Patent Application Publication
(10) Pub. No.: US 2025/0340427 A1
(43) Pub. Date: Nov. 6, 2025

(54) TAP ASSEMBLY

(71) Applicant: THE GREATER GOOD FRESH BREWING CO LTD, London (GB)

(72) Inventors: Gregory Charles Quinn, London (GB); Jed Taylor, London (GB); Alex Dixon, London (GB)

(21) Appl. No.: 18/866,193

(22) PCT Filed: May 17, 2023
(86) PCT No.: PCT/GB2023/051299

§ 371 Date: Nov. 15, 2024

(30) Foreign Application Priority Data
May 17, 2022 (GB) 2207212.8

(51) Int. Cl. B67D 1/14

(52) U.S. Cl. CPC B67D 1/1461

(57) ABSTRACT

A tap assembly (100) for a beverage container, wherein the tap assembly (100) is configured to selectively allow the passage of fluid along a fluid flow path from a source of pressurised fluid, comprising an inlet (102), an outlet (104), a first valve (120) for allowing passage therethrough, the first valve (120) comprising an orifice (124) and a first movable component (122) is movably located in the orifice (124), wherein the first movable component (122) and the orifice (124) have complementary shapes such that a flow area of the first valve (120) increases, from a rest position to a fully open position.

### FIELD OF THE INVENTION

The present invention relates to fluid dispensing taps and, more particularly, fluid dispensing taps for beverage containers (e.g for alcoholic beverages).

### BACKGROUND OF THE INVENTION

Many people enjoy drinking alcoholic beverages, such as beer, in their own homes. Often, consumers will purchase these beverages from shops or, alternatively, order them for delivery to their homes. Both ways of purchasing alcoholic beverages have their drawbacks. When purchasing from a shop, unless the amount purchased is very small, containers for alcoholic beverages are generally large, heavy and difficult to transport. When ordering alcoholic beverages for home delivery to remove this problem, the customer will need to make sure that they are at home when the delivery is made because the containers are generally large, which is restrictive and inflexible. Unlike soft drinks, which can be provided in concentrated form (e.g. fruit squash or cordial), alcoholic beverages require individual packaging, meaning that a large quantity of alcoholic beverage bottles and cans go to landfill. Additionally, alcoholic beverages purchased by either method (shop-bought or home delivery) are often provided in packaging that is environmentally unfriendly (e.g. using plastic to hold cans together) and duty must be paid on the alcoholic beverages, which drastically inflates the purchase price for consumers.

As a result of these problems, and also as a hobby, many people now choose to brew their own beer, or other alcoholic beverages, at home. Consequently, domestic brewing kits have become popular. Usually, in such kits, yeast is added to a mixture of sugary malt extract known as wort (which may be pre-hopped) and water in a fermentation container.

The yeast ferments the sugars in the malt extract to produce ethyl alcohol and release carbon dioxide (CO2). Some of this carbon dioxide dissolves into the beer and results in the carbonated nature of most beers, as well as affecting the flavour in a positive manner. Therefore, it can be beneficial to make use of this released carbon dioxide.

Once the beverage, such as beer, has fermented, it can either be conditioned and tapped from the same vessel, as seen in the Pinter sold by The Greater Good Fresh Brewing Co, or transferred to a secondary container. In either case, the pressure in the container will initially be high before any beer has been dispensed. Because of this, the flow rate during the initial tapping from the container can be unpredictable and fast resulting in imperfect tapping (e.g. with a large frothy head). In short, it is challenging to maintain well-carbonated beer whilst ensuring a predictable and desirable flow rate.

However, as more and more beer is tapped from the container, achieving a desirable flow rate can also be problematic. This is because as the beer is tapped repeatedly, the pressure within the container reduces progressively, meaning that the flow rate decreases. This gets worse as more tapping takes place until the flow rate becomes too low to ensure a reliable and desirable pour. The consistency of the pour also depends on the pressure at which the beer is tapped and can be affected even by small changes in the pressure.

In a commercial setting, this difficulty is usually overcome by the use of constant CO2 pressurisation which maintains the beer at a set pressure, which is usually user-adjustable via a dial. However, this solution requires significantly more equipment which is both more costly and bulky, and thus not suited to a home use environment. Further, the addition of secondary CO2, instead of the use of the naturally produced CO2, is environmentally unfriendly.

There is therefore a need to provide a tapping assembly and fermentation system that address these problems.

### SUMMARY OF THE INVENTION

According to a first aspect of the invention, a tap assembly for a beverage container is provided. The tap assembly is configured to selectively allow the passage of fluid along a fluid flow path from a source of pressurised fluid. The tap assembly comprises an inlet for receiving fluid from the source of pressurised fluid and which defines a start point of the fluid flow path, an outlet for dispensing the fluid and which defines an end point of the fluid flow path, a first valve for allowing passage of a fluid therethrough, the first valve comprising an orifice and a first movable component movably located within the orifice, an actuator, and a handle attached to the actuator and configured to be movable from a stopped position to a dispense position. The actuator is configured to be engaged with the first movable component such that movement of the handle is configured to move the first movable component from a rest position, at which the first movable component is in sealing contact with the orifice, to a fully open position, at which the first valve is fully open to fluid flow, such that movement of the handle causes fluid to be dispensed from the tap assembly. The first movable component and orifice have complementary shapes such that a flow area of the first valve increases, for example progressively increases, from the rest position to the fully open position.

The first movable component may comprise a tapered shape and the orifice may comprise a complementary tapered shape. The respective shapes may taper from a larger cross-section closer to the outlet to a narrower cross-section closer to the inlet.

Use of the first valve and, in particular, valve components having complementary shapes to ensure an increasing, or progressively increasing, flow area of the valve may enable the tap assembly to provide for adaptive tapping or fluid dispensing, even if the fluid source has a dynamically changing pressure.

The tap assembly may comprise a second valve for allowing passage of a fluid therethrough, wherein the first valve and second valve form part of the same fluid flow path. The second valve may comprise a second movable component and an aperture, wherein the second movable component seals against the aperture in a seated position. The second valve may be located downstream of the first valve. The aperture may comprise a raised lip and/or the second movable component may comprise a rubber seal to seal against the aperture in the seated position.

Use of a second valve may further ensure against the tap assembly leaking.

The tap assembly may comprise a first spring for biasing the first movable component towards the rest position.

The tap assembly may comprise a second spring for biasing the second movable component into the seated position.

The second movable component may be configured to be biased by fluid pressure to the seated position.

The tap assembly may comprise a restoring spring connected or coupled to the actuator for biasing the handle to the stopped position.

Generally, the use of these springs enables the valves to be restored to their closed positions. However, the use of these springs may also result in the handle being self-righting.

The first movable component may be attached to the actuator by a first actuator plate, and/or the second movable component may be attached to the actuator by a second actuator plate.

The first movable component and the first actuator plate may be movable in a first axial direction to open and close the first valve. Alternatively or in addition, the second movable component and second movable component may be movable in a second axial direction to open and close the second valve.

The actuator may comprise a pivot pin, the pivot pin configured to partially, at least partially, or wholly retain the actuator within the tap assembly while allowing the actuator to pivot about the axis of the pivot pin.

The actuator may comprise a guide pin, the guide pin being offset from the pivot pin such that the guide pin translates about the axis of the pivot pin as the actuator is pivoted.

The first actuator plate may comprise a first pivot pin slot configured to receive the pivot pin of the actuator so that the first actuator plate is able to move in the first axial direction relative to the actuator. Alternatively or in addition, the second actuator plate may comprise a second pivot pin slot configured to receive the pivot pin of the actuator so that the second actuator plate is able to move in the second axial direction relative to the actuator.

The first actuator plate may comprise a first guide pin slot configured to receive the guide pin of the actuator, wherein the first guide pin slot comprises a first cam profile such that the first actuator plate is configured to move in the first axial direction in response to movement of the guide pin within the first guide pin slot. Alternatively, or in addition, the second actuator plate may comprise a second guide pin slot configured to receive the guide pin of the actuator, wherein the second guide pin slot comprises a second cam profile such that the second actuator plate is configured to move in the second axial direction in response to movement of the guide pin within the second guide pin slot.

Use of such cam profiles may allow for the interaction between the handle movement and the opening of the first and second valves to be readily customised or tuned.

The tap assembly may be configured such that as the handle is moved from the stopped position, the second valve opens before the first valve opens. The first guide pin slot and/or the second guide pin slot may be configured so as to cause the second valve to open before the first valve opens as the handle is moved from the stopped position.

The first axial direction may be opposite to the second axial direction, such that when opening the first valve, the first actuator plate moves in an opposite direction to the direction that the second actuator plate moves when opening the second valve.

The handle may be movable to an intermediate position between the stopped position and the dispense position, wherein as the handle is moved from the stopped position and the intermediate position, the first valve is shut, and as the handle is moved from the intermediate position to the dispense position the first valve progressively opens. Further, as the handle is moved from the intermediate position to the dispense position, the rate of opening of the first valve may progressively increase.

The actuator may be configured to pivot with respect to the tap assembly, such that the handle moves in an angular path. The handle may move an angular distance of around 90 degrees, or 90 degrees, between the stopped position and the dispense position.

Use of a handle that moves in an angular path, and particularly across an angular distance of 90 degrees, may provide for a more natural and intuitive experience for the user, particularly relative to other dispensing taps which offer only binary on/off states and no flow control.

The tap assembly may comprise an attachment means for attachment to a fermentation vessel. The attachment means may comprise a threaded or keyed collar.

The tap assembly may comprise a wet section comprising the fluid flow path, and a dry section fluidically isolated from the wet section by seals, wherein the dry section comprises at least one of, or all of, the actuator, first actuator plate, second actuator plate, first spring, second spring, and restoring spring.

By fluidically isolating a number of the components, or parts of components, of the tap assembly from direct fluid flow, the risk of contaminating the fluid may be reduced and the risk of damaging these components may also reduce.

For a given distance of handle movement, the rate at which the flow area of the first valve changes may increase as the handle is moved further from the rest position.

By adjusting the rate of change of the flow area of the first valve for a given amount of handle movement, the tap assembly may be made particularly suitable for providing an adaptive tapping experience (for instance, maintaining consistent flow rates) despite inconsistent upstream fluid pressure (e.g. the vessel pressure dynamically changing).

In another aspect of the invention, a fermentation system is provided. The fermentation system comprises a fermentation vessel as well as any of the above described tap assemblies.

### BRIEF DESCRIPTION OF THE DRAWINGS

FIG. 1 shows a general overview of a tap assembly according to the invention.

FIG. 2 shows an internal view of the tap assembly of FIG. 1.

FIG. 3 shows a first side view of the tap assembly of FIG. 1.

FIG. 4 shows a second side view of the tap assembly of FIG. 1.

### DETAILED DESCRIPTION OF THE INVENTION

The inventors have realised that the pressure at which beer is held can have a significant effect on the quality of the dispensed beer, including, for instance, the number and size of the bubbles in the head of the beer, as well as the level of carbonation of the beer itself. The inventors have also discovered through pressure mapping experiments that by better accounting for the pressure of the beer, tapping quality can be improved.

As the inventors have realised, one potential reason for this is that, at high pressures, the flow of beer can be turbulent. This turbulence can lead to a large amount of dissolved CO2 suddenly releasing from the solution, and therefore poor head quality and too much froth. In contrast, at low pressures, the flow rate of the beverage may be too low for the often desired ‘foamy head’ to form. At intermediate pressures, the head quality may be improved, but will be prone to changing as the pressure drops from high to low pressure.

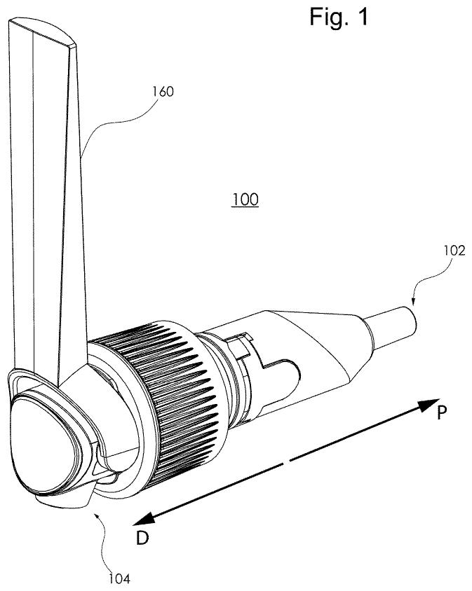

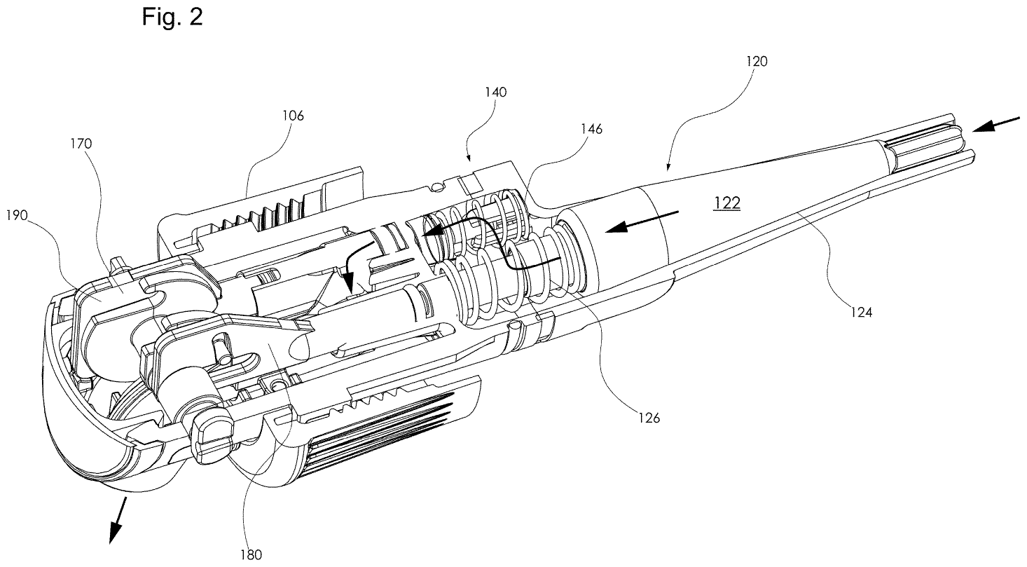

As detailed below, the present invention solves this problem. In particular, as shown in FIG. 1, the invention provides a tap assembly 100 for coupling to a beverage container (not shown), with the beverage container containing beer (or another beverage) at pressure. As shown, the tap assembly 100 comprises a fluid path for the passage of beer from the apparatus to a drinking glass or other receptacle or container, wherein the fluid path extends from an inlet 102 to an outlet 104. As shown, the inlet 102 end of the tap assembly 100 is considered proximal and the outlet 104 end of the tap assembly 100 is considered distal, thus defining a proximal (P) and a distal (D) direction for the purpose of this description. As explained in the following paragraph, and as shown at FIG. 2, the fluid path can be closed to the passage of fluid at an upstream location (i.e. through a first valve 120) and at a downstream location (i.e. through a second valve 140), such that the path must be open to the passage of fluid at both locations (i.e. both valves 120, 140) to allow for the proper passage of fluid. The path of fluid flow is generally shown by the arrows at FIG. 2.

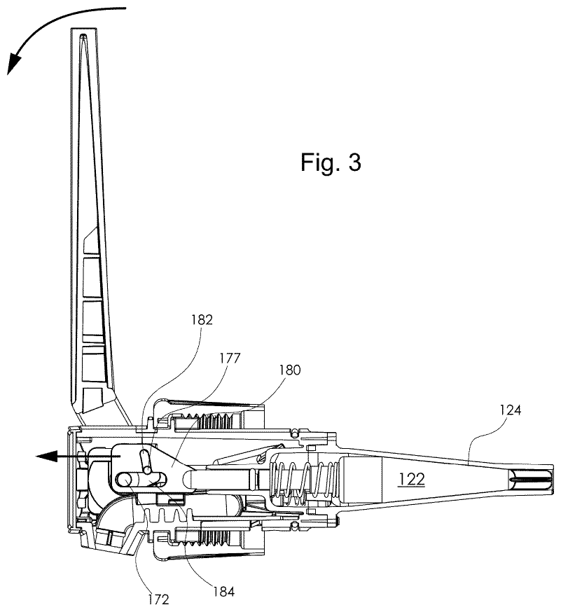

As better shown at FIG. 3, the tap assembly 100 comprises a first valve 120 comprising a first movable component 122, or stopper, and an orifice 124, wherein the first movable component 122 is slidably located within the orifice 124. As explained in further detail below, the first valve 120 is configured to close the fluid path to the passage of fluid (i.e. prevent fluid communication) when the first movable component 122 is in a rest position (i.e. in sealing contact with the orifice). By sliding in an axial direction within the orifice 124, the first movable component 122 is movable from the rest position to a fully open position in which passage of fluid is minimally inhibited by the first valve 120. As will be described further below, the shape of the first movable component 122 and the orifice 124 means that the flow area provided by the valve is dependent on the position of the first movable component 122. The flow area may be defined as a cross-sectional area perpendicular to the general direction of fluid flow. In particular, when the first movable component 122 is located at positions between the rest position and the fully open position, the first valve 120 inhibits the passage of fluid to a different extent; when the first movable component 122 is located proximal to its rest position, it inhibits the passage of fluid to a greater extent, whereas when the first movable component 122 is located proximal to the fully open position, it inhibits the passage of fluid to a lesser extent.

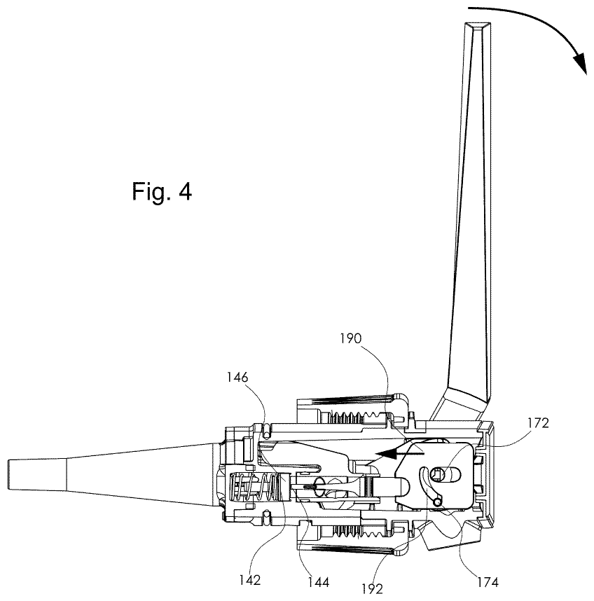

As better shown at FIG. 4, the tap assembly 100 comprises a second valve 140 comprising a second movable component 142, or sealing pad, and an aperture 144, wherein the second movable component 142 is in movable contact with the aperture 144. In use, the second valve 140 is located downstream of the first valve 120 and, as explained in further detail below, is configured to close the fluid path to the passage of fluid at a position downstream of the first valve 120 when the second movable component 142 is in its seated position (i.e. it is seated within the aperture 144). The second movable component 142 is movable to an open position away from the aperture 144 to thereby allow the passage of fluid through the aperture 144.

In this embodiment, a user interacts with the tap assembly 100 using a handle 160 which is attached (e.g. removably attached) to an actuator 170 (see FIG. 2). The handle 160 enables the user to move (e.g. pivot) the actuator 170. As will be described further, the actuator is engaged with the first 122 and second 142 movable components by respective first 180 and second 190 actuator plates (see FIGS. 3 and 4), which are in turn attached (i.e. directly coupled) to the respective first 122 and second 142 movable components. In this embodiment, by pulling the handle 160 as a lever, the user is able to move the first 180 and second 190 actuator plates and thereby move the respective first 122 and second 142 movable components to allow for the passage of fluid.

As will be described further, the use of the first valve 120 provides for graduated adjustment of the tapping in respect of the vessel pressure. This is because the flow area provided by the first valve 120 depends on the degree to which the user has moved the handle 160 from its stopped position. As such, the user can intuitively move the handle 160 to better compensate for the dynamic pressure of the vessel (i.e. at a low vessel pressure, a user may move the handle 160 further from the stopped position than they would at a high vessel pressure). Further to this, the use of the first 120 and second 140 valves is advantageous as the second valve can further prevent undesired flow along the flow path while both the first and second valve are closed, while retaining a user-friendly, intuitive and adaptive tapping experience.

With respect to the first valve 120, this is described further with respect to FIG. 2. As can be seen, the first movable component 122 of the first valve 120 has a tapered conic shape and the orifice 124 has a complementary tapered shape. Both the orifice 124 and the first movable component 122 are typically formed of a plastics material e.g. a hard plastics material which, in this embodiment, is acrylonitrile butadiene styrene (ABS), although other suitable materials could be used. The shape of the first movable component 122 and the shape of the orifice 124 are configured such that the first movable component 122 will seal the orifice 124, and therefore the first valve 120, to the passage of fluid when the first movable component 122 is in sealing contact with the orifice 124. As shown, the first movable component 122 and the orifice 124 share the same longitudinal axis, and the first movable component 122 is configured to move axially towards and away from the orifice 124 along the longitudinal axis. As will be clear from the drawings, the tapered shapes of the first movable component 122 and orifice 124 mean that as the first movable component 122 moves from its rest position (i.e. in sealing contact with the orifice 124) towards its fully open position (that is, at its furthest position from the orifice 124), the flow area provided by the first valve 120 increases. Because of this increase in flow area, the first valve 120 acts to progressively control the passage of fluid flow. It is this feature that allows for the user to compensate for the dynamic pressure of the vessel by adjusting the handle 160 position to best set the flow area through the first valve 120. Further, the respective shapes of the first movable component 122 and the orifice 124 taper from a broader cross-section at a downstream position to a narrower position upstream; the direction of this tapering provides particularly good flow characteristics.

With respect to the second valve 140, this is described further with respect to FIG. 3. As can be seen from FIG. 2 the second valve 140 is located downstream of the first valve 120 such that the second valve 140 is configured to receive fluid that has already flowed through the first valve 120. As mentioned, the second valve 140 comprises the second movable component 142 together with the aperture 144 in which the second movable component 142 sits in order to seal the aperture 144. The second movable component 142 comprises a pad area typically formed of rubber (although other suitable materials could be used), which pad area is configured to deform about a raised lip 146 of the aperture 144; in this way, an effective seal can be provided.

As can be seen, the first 122 and second 142 movable components are biased to their respective rest and seated positions by first 126 and second 146 springs, respectively. This results in both valves 120, 140 being closed unless the user actively operates the handle 160 and actuator 170 to open the valves 120, 140. As can be seen, the second movable component 142 is additionally urged to its seated position by the action of the fluid pressure; however, in contrast, the first movable component 122 is urged by the action of fluid pressure towards its fully open position.

It is at least partly because the first movable component 122 is urged by the action of fluid pressure towards its fully open position that the use of the second valve 140 is advantageous. In particular, because the fluid pressure urges the first valve 120 to open, and because the first movable component 122 and orifice 124 both comprise hard plastics material, there is a risk that the first valve 120 could, in certain circumstances, leak fluid. In view of this, the second valve 140, which is rubberised and urged shut by the fluid pressure, can be used to ensure watertightness.

However, as alternatives, or in addition, to the use of a second valve 140, the invention also envisages the first valve 120 being used in an opposite orientation wherein the respective shapes of the first movable component 122 and the orifice 124 taper from a broader cross-section at an upstream position to a narrower position at a downstream location, although this tends to result in poorer flow characteristics. In this orientation, the first valve 120 may be urged shut by fluid pressure. Similarly, the materials of the first valve 120 could be adapted to provide an improved seal when shut; for instance, at least one of the first movable component 122 or orifice 124 could be formed from a rubber material, which could seal better against the other of the first movable component 122 or orifice 124 when the first valve 120 is in the rest position (i.e. when shut).

As discussed, the actuator 170 and handle 160 are operated by the user to open both the first 120 and second 140 valves. The opening of the two valves 120, 140 is configured to occur in sequence as the handle 160 is pulled from a stopped position towards an intermediate position and then towards a dispense position. In operation, as the handle 160 is pulled from the stopped to dispense position, it traverses an angle of 90 degrees (or around 90 degrees). In particular, at the stopped position, both the first 120 and second 140 valve are closed. Initially, as the handle 160 is moved from the stopped position towards the intermediate position, the second valve 140 begins to open, while the first valve 120 remains fully closed. Subsequently, as the handle 160 is moved from the intermediate position towards the dispense position, the first valve 120 begins to open. In this embodiment, both the first 120 and second 140 valve are fully open at the dispense position. The second valve 140 may be fully open at the intermediate position, or it may fully open at a position between the intermediate position and the dispense position (that is, the first valve 120 may begin to open before the second valve 140 is fully open).

The first 180 and second 190 actuator plates link the actuator 170 to the respective first 122 and second 142 movable components in order to provide the sequential opening described above. In particular, as shown at FIGS. 3 and 4, the first 180 and second 190 actuator plates comprise respective first 184 and second (not shown) pivot pin slots and respective first 182 and second 192 guide slots. As shown, the first 184 and second pivot pin slots are straight cut slots through which a pivot pin 172 of the actuator 170 passes; these slots enable axial movement of the first 180 and second 190 actuator plates relative to the actuator 170 as the handle 160 is pulled. As also shown, the first 182 and second 192 guide slots form curved ‘cam’ paths or profiles configured to receive a respective guide pin 174 of the actuator 170. In operation, the guide pins 174 of the actuator 170 move in a substantially circular path about the pivot pin 172 of the actuator 170 as the handle 160 is pulled. Because of this circular motion, as the handle 160 is pulled, the guide pins 174 interact with the respective first 182 and second 192 guide slots to cause the respective first 180 and second 190 actuator plates to move axially with respect to the actuator 170 and handle 160. In this embodiment, the first 180 and second 190 actuator plates move in opposite axial directions as the handle 160 is pulled. In particular, the first actuator plate 180 moves distally to move the first movable component 122 distally to open the first valve 120, whereas the second actuator plate 190 moves proximally to move the second movable component 142 proximally to open the second valve 140. By varying the cam profile of the first 182 and second 192 guide slots, the direction in which, and the rate at which, the respective first 180 and second 190 actuator plates move relative to the actuator 170 as the handle 160 is pulled can also be varied.

In the present embodiment, the cam profiles of the first 182 and second 192 guide slots are configured such that only the second actuator plate 190 moves in response to the movement of the handle 160 from the stopped position to the intermediate position, and such that only the first actuator plate 180 moves in response to the movement of the handle 160 from the intermediate position to the dispense position. Further, the cam profiles of the first 182 and second 192 guide slots are configured such that the angular distance between the stopped and intermediate position is relatively small (for instance, 10 degrees, or approximately 10 degrees) compared to the angular distance between the intermediate and dispense position (for instance, 80 degrees, or approximately 80 degrees). The cam profile of the first guide slot 182 may further be configured such that the rate at which the first valve 120 opens increases progressively as the angular distance from the intermediate position increases; for instance, in the first 5 degrees of movement from the intermediate position, the first valve 120 may open a smaller amount (e.g. the flow area may increase a small amount), and in the last 5 degrees of movement towards the dispense position, the first valve 120 may open a larger amount (e.g. the flow area may increase a large amount). That is to say, that the rate of change of the flow area of the first valve 120 for a given distance the handle 160 is moved from the rest position may increase the further the handle 160 is moved from the rest position. As described, this may be achieved by customising or tuning the cam profiles; however, it is envisaged that it could be achieved without use of cam profiles.

As the handle 160 and actuator 170 are configured to move the actuator plates 180, 190, so too are the actuator plates 180, 190 configured to move the handle 160 and actuator 170. In particular, as the first 120 and second 140 valves are closed under the action of the respective first 126 and second 146 springs (and/or fluid pressure), the resultant movement of the respective first 180 and second 190 actuator plates causes the handle 160 to move towards the stopped position, assuming the user is not pulling it. In this way, the handle 160 is self-righting. However, a restoring spring (not shown) is also connected directly to the actuator 170 to provide a further restoring force which also acts to move the handle 160 towards the stopped position.

In use, the tap assembly 100 is configured for use with a fermentation vessel and, in particular, the tap assembly 100 is configured to be inserted at least partially inside a fermentation vessel such that the majority of the tap assembly 100 would be located inside the fermentation vessel in use. In this manner, the tap assembly 100 and vessel may comprise corresponding attachment means, such that the tap assembly 100 can be securely attached to, and removed from, the vessel. These attachment means may comprise corresponding threaded sections or corresponding keyed sections, for instance. As shown, the tap assembly 100 comprises a threaded collar 106 for connection to a vessel, such as a fermentation vessel.

As will be clear, the nature of the tap assembly 100 means that some components will inherently be exposed to the flowing fluid. However, the tap assembly 100 of the present embodiment is designed in such a manner that this exposure is limited. In particular, the tap assembly 100 may be formed of two parts, or shells, which fit together to form an enclosed space. This enclosed space may house one of, any of, or all of the first valve 120, second valve 140, actuator 170, and first 180 and second 190 actuator plates. The enclosed space may delimit a flow path section (i.e. a wet section) comprising the first valve 120 and second valve 140 in which section the flow of fluid is contained; a seal between the two parts or shells, as well as seals located on the first 122 and second 142 movable components and/or first 180 and second 190 actuator plates, may enable the wet section to be fluidically isolated. These seals may be o-rings, for instance. The remainder of the enclosed space is, in normal operation, absent fluid and may therefore be considered a ‘dry’ section. This dry section may comprise one of, any of, or all of the actuator 170, the first 180 and second 190 actuation plates, and may further comprise at least a portion of the first 122 and second 142 movable components. By isolating these components from fluid flow, there is a reduced risk of the fluid adversely affecting these components (e.g. leaving residue or causing rust); there is also a reduced risk of the fluid becoming adversely affected by these components, since they are fluidically isolated from the fluid.

A number of variations are now described, although the invention is not limited to only these variations.

While the above tap assembly 100 is described as using two valves 120, 140, it is possible that a tap assembly 100 could function with only the first valve 120, as this would still provide for a user-friendly means for compensating for the changing pressure in the fermentation vessel.

Further, while the first movable component 122 is shown as tapering from a broader cross-section downstream to a narrower cross-section upstream, it is possible that different profiles could be used. For instance, it is possible that the respective shapes taper from a broader cross-section at an upstream location to a narrower cross-section at a downstream location.

The first movable component 122 is described as having a tapered conic shape, while the orifice 124 is described as having a complementary tapered shape. However, in some embodiments the shapes may differ; for instance, only one of the first movable component 122 and orifice 124 may be tapered. Similarly, rather than a tapered conic shape either of the first movable component 122 and orifice 124 may have curved, curvilinear, spherical, frustoconical, and pyramidal shapes.

While it has been described that the handle 160 can be moved through an angular path (i.e. acts as a lever), it is also possible that the handle 160 can be moved through a linear path.

In the above described embodiment, the guide pins 174 are offset from one another. However, the guide pins 172 may also be co-linear.

While the above discussion relates to one specific embodiment of the tap assembly 100, variations on the above features are envisaged. For instance, while this description frequently makes use of the term “beer”, this term is interchangeable with other types of beverage (e.g. alcoholic beverage) that are fermented and dispensed in similar ways including, for instance, cider. As such, the scope of the invention is defined only by the appended claims.

1. A tap assembly for a beverage container, wherein the tap assembly is configured to selectively allow the passage of fluid along a fluid flow path from a source of pressurised fluid, comprising:
an inlet for receiving fluid from the source of pressurised fluid and which defines a start point of the fluid flow path;
an outlet for dispensing the fluid and which defines an end point of the fluid flow path;
a first valve for allowing passage of a fluid therethrough, the first valve comprising an orifice and a first movable component movably located within the orifice;
an actuator; and
a handle attached to the actuator and configured to be movable from a stopped position to a dispense position,
wherein the actuator is configured to be engaged with the first movable component such that movement of the handle is configured to move the first movable component from a rest position, at which the first movable component is in sealing contact with the orifice, to a fully open position, at which the first valve is fully open to fluid flow, such that movement of the handle causes fluid to be dispensed from the tap assembly,
wherein the first movable component and orifice have complementary shapes such that a flow area of the first valve increases, or progressively increases, from the rest position to the fully open position,
wherein the handle is movable to an intermediate position between the stopped position and the dispense position, wherein as the handle is moved from the stopped position to the intermediate position, the first valve is in the rest position, and as the handle is moved from the intermediate position to the dispense position the first valve progressively opens.

2. The tap assembly of claim 1, wherein the first movable component comprises a tapered shape and the orifice comprises a complementary tapered shape, optionally wherein the respective shapes taper from a larger cross-section closer to the outlet to a narrower cross-section closer to the inlet.

3. The tap assembly of claim 1, wherein the tap assembly comprises a second valve for allowing passage of a fluid therethrough, wherein the first valve and second valve form part of the same fluid flow path.

4. The tap assembly of claim 3, wherein the second valve comprises a second movable component and an aperture, wherein the second movable component seals against the aperture in a seated position.

5. The tap assembly of claim 3, wherein the second valve is located downstream of the first valve.

6. The tap assembly of claim 4, wherein the aperture comprises a raised lip and/or wherein the second movable component comprises a rubber seal to seal against the aperture in the seated position.

7. The tap assembly of claim 1, including at least one of the following:
the tap assembly comprises a first spring for biasing the first movable component towards the rest position;
the tap assembly comprises a second spring for biasing the second movable component into the seated position and/or wherein the second movable component is configured to be biased by fluid pressure to the seated position; and
the tap assembly comprises a restoring spring connected or coupled to the actuator for biasing the handle to the stopped position.

8. (canceled)

9. (canceled)

10. The tap assembly of claim 7, wherein the first movable component is attached to the actuator by a first actuator plate, and/or wherein the second movable component is attached to the actuator by a second actuator plate.

11. The tap assembly of claim 10, wherein the first movable component and the first actuator plate are movable in a first axial direction to open and close the first valve, and/or the second movable component and second movable component are movable in a second axial direction to open and close the second valve.

12. The tap assembly of claim 1, wherein the actuator comprises one of:
a) a pivot pin, the pivot pin configured to partially, at least partially, or wholly retain the actuator within the tap assembly while allowing the actuator to pivot about the axis of the pivot pin; or
b) the pivot point of a) and a guide pin, the guide pin being offset from the pivot pin such that the guide pin translates about the axis of the pivot pin as the actuator is pivoted.

13. (canceled)

14. The tap assembly of claim 11, wherein the actuator comprises a pivot pin, the pivot pin configured to partially, at least partially, or wholly retain the actuator within the tap assembly while allowing the actuator to pivot about the axis of the pivot, and wherein the first actuator plate comprises a first pivot pin slot configured to receive the pivot pin of the actuator so that the first actuator plate is able to move in the first axial direction relative to the actuator, and/or wherein the second actuator plate comprises a second pivot pin slot configured to receive the pivot pin of the actuator so that the second actuator plate is able to move in the second axial direction relative to the actuator.

15. The tap assembly of claim 1, wherein the actuator comprises a pivot pin, the pivot pin configured to partially, at least partially, or wholly retain the actuator within the tap assembly while allowing the actuator to pivot about the axis of pivot,
wherein the actuator comprises a guide pin, the guide pin being offset from the pivot pin such that the guide pin translates about the axis of the pivot pin as the actuator is pivoted,
wherein the first actuator plate comprises a first guide pin slot configured to receive the guide pin of the actuator, wherein the first guide pin slot comprises a first cam profile such that the first actuator plate is configured to move in the first axial direction in response to movement of the guide pin within the first guide pin slot and/or wherein the second actuator plate comprises a second guide pin slot configured to receive the guide pin of the actuator, wherein the second guide pin slot comprises a second cam profile such that the second actuator plate is configured to move in the second axial direction in response to movement of the guide pin within the second guide pin slot.

16. The tap assembly of claim 3, wherein the tap assembly is configured such that as the handle is moved from the stopped position, the second valve opens before the first valve opens.

17. The tap assembly of claim 16, wherein the first guide pin slot and/or the second guide pin slot are configured so as to cause the second valve to open before the first valve opens as the handle is moved from the stopped position.

18. The tap assembly of claim 11, wherein the first axial direction is opposite to the second axial direction, such that when opening the first valve, the first actuator plate moves in an opposite direction to the direction that the second actuator plate moves when opening the second valve.

19. The tap assembly of claim 1, including at least one of the following:
wherein as the handle is moved from the intermediate position to the dispense position, the rate of opening of the first valve progressively increases; and
wherein for a given distance of handle movement, the rate at which a flow area of the first valve changes increases as the handle is moved further from the rest position.

20. The tap assembly of claim 1, wherein the actuator is configured to pivot with respect to the tap assembly, such that the handle moves in an angular path, optionally wherein the handle moves an angular distance of around 90 degrees, or 90 degrees, between the stopped position and the dispense position.

21. The tap assembly of claim 1, wherein the tap assembly comprises an attachment means for attachment to a fermentation vessel, optionally wherein the attachment means comprises a threaded or keyed collar.

22. The tap assembly of claim 10, wherein the tap assembly comprises a wet section comprising the fluid flow path, and a dry section fluidically isolated from the wet section by seals, wherein the dry section comprises at least one of, or all of, the actuator, the first actuator plate, the second actuator plate, the first spring, the second spring, and the restoring spring.

23. (canceled)

24. A fermentation system comprising a fermentation vessel and a tap assembly according to claim 1.
